(19) United States
(12) Patent Application Publication
(10) Pub. No.: US 2007/0297080 A1
(43) Pub. Date: Dec. 27, 2007

(54) Apparatus and method for bending a slider to create rounded corners on its trailing edge in a hard disk drive

(76) Inventor: SungChang Lee, San Jose, CA (US)

Correspondence Address: GREGORY SMITH & ASSOCIATES, 3900 NEWPARK MALL ROAD, 3RD FLOOR, NEWARK, CA, 94560, US

(21) Appl. No.: 11/474,127

(22) Filed: Jun. 23, 2006

(51) Int. Cl. G11B 5/02; G11B 5/60

(52) U.S. Cl. 360/59; 360/234.5

(57) ABSTRACT

A method of rounding corners of a slider's trailing edge by applying at least a first voltage to terminals of a bending device coupled to the slider. The slider including terminals, possibly bending device and/or vertical micro-actuator. The flexure finger, head gimbal assembly, with trace path(s) to the terminals. The head stack assembly, embedded circuit, and hard disk drive applying at least first voltage when loading/unloading the head stack assembly from ramp. Manufacturing the slider, the flexure finger, the head gimbal assembly, the head stack assembly, the embedded circuit, and the hard disk drive, as well as these items as products of the invention's manufacturing processes.

### TECHNICAL FIELD

This invention relates to manipulating sliders in hard disk drives, in particular, to apparatus and methods for bending the slider to create rounded corners of its trailing edge in a hard disk drive during load and unload operations.

### BACKGROUND OF THE INVENTION

Hard disk drives include an actuator assembly pivoting through an actuator pivot to position one or more read-write heads, embedded in sliders, each over a rotating disk surface. The data stored on the rotating disk surface is typically arranged in concentric tracks. To access the data of a track, a servo controller first positions the read-write head by electrically stimulating the voice coil motor, which couples through the voice coil and an actuator arm to move a head gimbal assembly in lateral positioning the slider close to the track. Once the read-write head is close to the track, the servo controller typically enters an operational mode known herein as track following. It is during track following mode that the read-write head is used to access the data stored of the track. Micro-actuators frequently provide a second actuation stage for lateral positioning the read-write head during track following mode.

Through the history of disk drive development, there have been two schemes for parking the actuator assembly when not in operation. One of these is often referred to as the Contact Start-Stop (CSS) approach, which actually parks the read-write heads in contact with the disk surface. The other approach uses a ramp to move the head gimbal assemblies into a latch, positioning the heads off the disk surfaces. The invention relates to hard disk drives using this load/unload approach. It is known in the prior art that when the corners of the trailing edge of the slider are rounded, there is significantly less contact damage from the load and unload operations. However, the prior art speaks only to reusing worn sliders to achieve the rounded edges. What is needed is a slider which has rounded edges when loading and unloading, a slider which has a reasonable cost of production.

### SUMMARY OF THE INVENTION

The invention includes a method of operating a slider in a hard disk drive by applying at least a first voltage between a first and second terminal, stimulating a bending device coupled to the slider, to produce a bending effect acting on the slider, creating a rounding at a first and second corner of the trailing edge of the slider. When at most a second voltage is applied between these terminals, the first and second corners flatten. The second voltage is smaller in magnitude than the first voltage.

The second voltage being smaller in magnitude than the first voltage may refer to any one of the following. The absolute value of the second voltage is less than the absolute value of the first voltage. The absolute value of the second voltage is less than or equal to the absolute value of the first voltage. The second voltage is less than the absolute value of the first voltage. The second voltage is less than or equal to the absolute value of the first voltage.

The invention's bending device includes the first terminal T1 and the second terminal T2 electrically coupling to produce the bending effect for acting on the slider and may include at least one of the following. The first terminal electrically coupling to a bending device piezoelectric film electrically coupled to the second terminal to expand to produce the bending effect upon stimulation by at least the first voltage. The first terminal electrically coupling through a heater to the second terminal to heat a bending layer coupled to the slider to produce the bending effect upon stimulation by at least the first voltage.

The bending device piezoelectric film includes at least one of lead, zirconium, and tungsten. The bending layer includes at least one conductive material and/or a shape memory alloy. The conductive material preferably includes copper and/or silver and/or lead and/or gold. The shape memory alloy preferably includes at least one solid material having at least two solid phases, wherein when the solid material is subjected to changes in temperature or pressure, the solid material tends change thermodynamic state in a manner selected from the group consisting of: from a first of the solid phases to a second of the solid phases; and from the second solid phase to the first solid phase.

The invention's slider includes the first terminal and the second terminal. Preferably, the slider includes the bending device to round the first corner and the second corner of its trailing edge. The slider's read head may employ a spin valve or a tunnel valve. The slider may preferably include a vertical micro-actuator stimulated by a third voltage across a fourth and fifth terminal to alter the vertical position of the read-write head above a rotating disk surface. The first terminal may preferably be electrically coupled to the third terminal.

The invention's flexure finger couples to the slider and includes a first trace path for electrically coupling to the first terminal and/or a second trace path for electrically coupled to the second terminal. The flexure finger may preferably further include a micro-actuator assembly for coupling to the slider. The micro-actuator assembly preferably aids the slider in its lateral position and/or its vertical position, and may employ a piezoelectric effect, a thermal-mechanical effect as discussed for the vertical micro-actuator and/or an electrostatic effect.

The invention's head gimbal assembly preferably includes the flexure finger coupling to the slider, which preferably includes the first trace path electrically coupled to the first terminal and/or the second trace path electrically coupled to the second terminal. The head gimbal assembly may further include the load beam electrically coupling through the flexure finger to the first terminal.

The invention's head stack assembly includes a head stack coupling through an actuator arm to at least one head gimbal assembly. The head stack may couple through at least two actuator arms, each of which may couple to at least one head gimbal assembly. The head stack assembly operates as follows. The head stack assembly is prepared to be loaded onto a parking ramp by applying at least the first voltage between the first and second terminal, stimulating the bending device, and rounding the corners of the trailing edge of each slider included in the head stack assembly. Similarly, the head stack assembly is prepared to unload from the parking ramp by applying at least the first voltage between the first and second terminal, again rounding the corners.

The invention's embedded circuit supports the operation of the head stack assembly in the hard disk drive by including the means for preparing to load the head stack assembly onto the parking ramp and the means for preparing to unload the head stack assembly from the parking ramp, both by applying at least the first voltage between the first terminal and the second terminal of the bending device coupled to the slider, for each slider included in the head stack assembly.

At least one of these means and is at least partly implemented by at least one instance of a driver receiving a first signal to provide a voltage of at least the first voltage across the first and the second terminals of the bending devices, and/or a finite state machine driving the first signal and/or a computer driving the first signal, accessibly coupled to a memory and directed by a program system including at least one program step residing in the memory to support the means. The computer may serve as the servo computer, whose primary task is to follow a track based in part upon the Position Error Signal. Alternatively the computer may serve as the embedded computer when reading the track.

The program system may preferably include program steps supporting the operations of the head stack assembly in preparing to load and preparing to unload the head stack assembly by applying a voltage of at least the first voltage to the bending device coupled to each slider included in the head stack assembly.

The invention's hard disk drive preferably includes the head stack assembly electrically coupled to the embedded circuit to provide at least the first voltage between the first terminal and the second terminal of the bending device coupled to each slider in the head stack assembly, when preparing to load or preparing to unload the head stack assembly from the parking ramp. The parking ramp may be located near the spindle shaft coupling at least one disk to the spindle motor, or located near the outside diameter of at least one disk.

The invention includes methods for manufacturing the slider, the flexure finger, the head gimbal assembly, the head stack assembly, the embedded circuit, and the hard disk drive, as well as these items as products of the invention's manufacturing processes.

### BRIEF DESCRIPTION OF THE DRAWINGS

FIG. 1A shows a simplified perspective view of the air bearing surface of a slider in accord with the invention;

FIGS. 1B, 2A, 2C and 3A show a cross section taken through the A line of FIG. 1A of slider with at most a second voltage across the first and second terminals showing the corners of the trailing edge of the slider flattened;

FIGS. 1C, 2B, and 2D show a cross section taken through the A line of FIG. 1A of slider with at least a first voltage across the first and second terminals showing the corners of the trailing edge of the slider rounded;

FIG. 3B shows a partially assembled hard disk drive including a parking ramp near the spindle shaft in accord with the invention;

FIG. 4A shows a partially assembled hard disk drive including a parking ramp near the outside diameter of the disk in accord with the invention;

FIGS. 4B to 5D show some details of the flexure finger, the slider, the head gimbal assembly and the hard disk drive in accord with the invention;

FIGS. 6 to 10 shows some details of the embedded circuit and the hard disk drive in accord with the invention;

FIGS. 11A and 11B show a head gimbal assembly using a micro-actuator assembly employing an electrostatic effect to alter the position of the read-write head;

FIGS. 12A and 12B show some details of the read head of the slider;

FIGS. 12C and 12D show some details of the magnetic polarization of a track on the disk surface; and

FIGS. 13A and 13B show some details of alternative air bearing surfaces.

### DETAILED DESCRIPTION

This invention relates to manipulating sliders in hard disk drives, in particular, to apparatus and methods for bending the slider to create rounded corners of its trailing edge in a hard disk drive during load and unload operations.

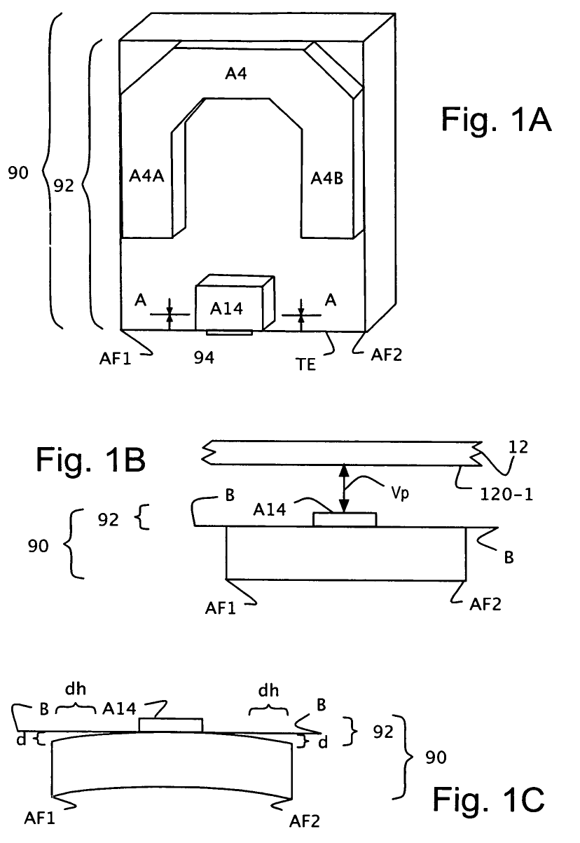

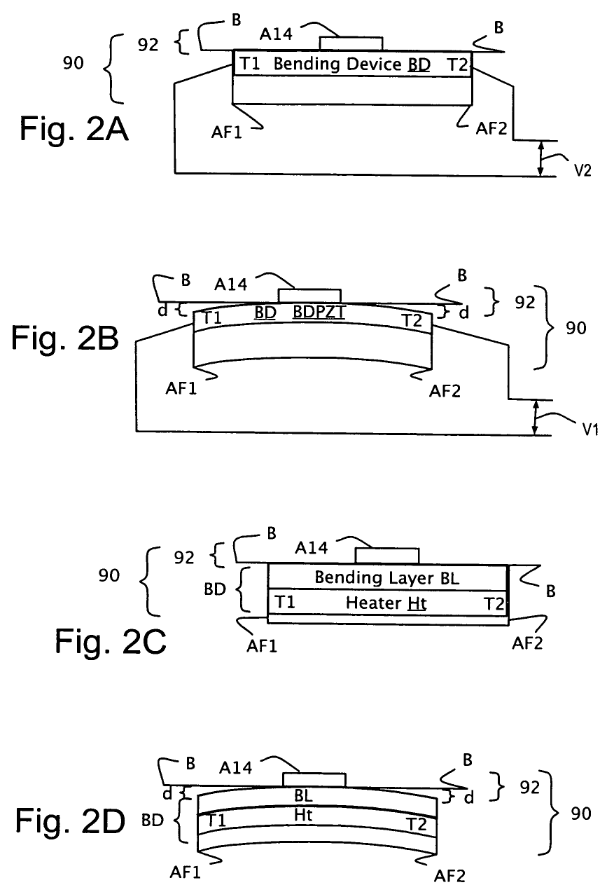

The invention includes a method of operating a slider 90 in a hard disk drive 10 by applying at least a first voltage V1 between a first terminal T1 and a second terminal T2, stimulating a bending device BD coupled to the slider, to produce a bending effect acting on the slider, creating a rounding at a first corner AF1 and at a second corner AF2 of the trailing edge TE of the slider, as shown in FIGS. 1C, 2B, and 2D. Today, what is typically needed is that over a horizontal distance dh of about 50 micrometers, there is a deflection d of 150 nanometers. When at most a second voltage V2 is applied between these terminals, the first and second corners flatten as shown in FIGS. 1A, 1B, 2A, 2C, 3A, 13A and 13B. The second voltage is smaller in magnitude than the first voltage.

The second voltage V2 being smaller in magnitude than the first voltage V1 may refer to any one of the following. The absolute value of the second voltage is less than the absolute value of the first voltage. The absolute value of the second voltage is less than or equal to the absolute value of the first voltage. The second voltage is less than the absolute value of the first voltage. The second voltage is less than or equal to the absolute value of the first voltage.

The invention's bending device BD includes the first terminal T1 and the second terminal T2 electrically coupling to produce the bending effect for acting on the slider and may include at least one of the following. The first terminal electrically coupling to a bending device piezoelectric film BDPZT electrically coupled to the second terminal to expand to produce the bending effect upon stimulation by at least the first voltage V1. The first terminal electrically coupling through a heater Ht to the second terminal to heat a bending layer BL coupled to the slider 90 to produce the bending effect upon stimulation by at least the first voltage. The first terminal electrically coupling through the heater to the second terminal may further include the first terminal electrically coupling through a first heating element H1 to a third terminal T3 electrically coupling through a second heating element H2 to the second terminal.

The bending device piezoelectric film BDPZT includes at least one of lead, zirconium, and tungsten. The bending layer BL includes at least one conductive material and/or a shape memory alloy. The conductive material preferably includes copper and/or silver and/or lead and/or gold. The shape memory alloy preferably includes at least one solid material having at least two solid phases, wherein when the solid material is subjected to changes in temperature or pressure, the solid material tends change thermodynamic state in a manner selected from the group consisting of: from a first of the solid phases to a second of the solid phases; and from the second solid phase to the first solid phase.

As used herein a shape memory alloy of two or more elements will refer to any molecular or crystalline combination of those elements which is a solid possessing the shape memory property of two solid phases in the operating and storage conditions of a hard disk drive.

The shape memory alloy may include at least one member of the titanium nickel shape memory alloy group consisting of: a Titanium Nickel (TiNi) alloy, a Titanium Nickel Iron (Ti—Ni—Fe) alloy, a Titanium Nickel Copper (Ti—Ni—Cu) alloy, a Titanium Nickel Lead (Ti—Ni—Pb) alloy, and a Titanium Nickel Hafnium (Ti—Ni—Hf) alloy.

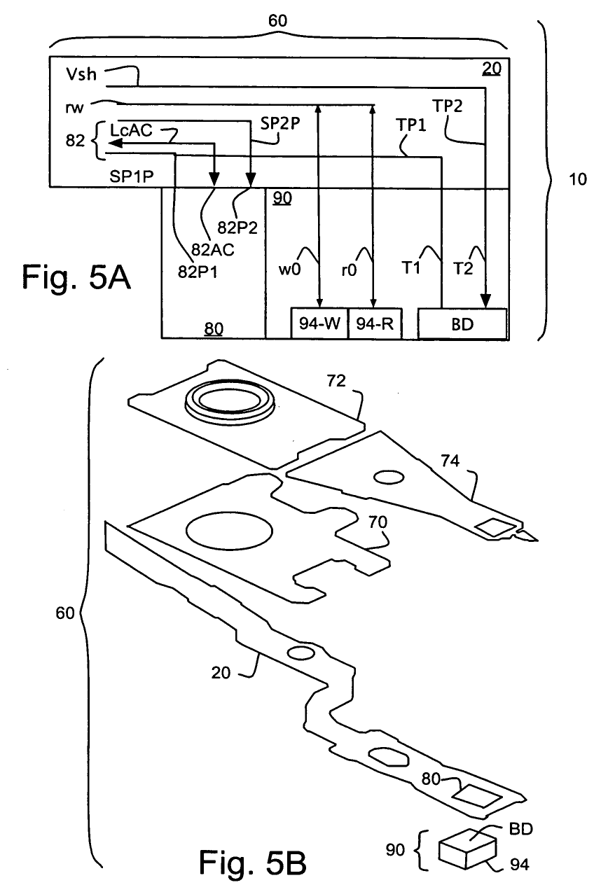

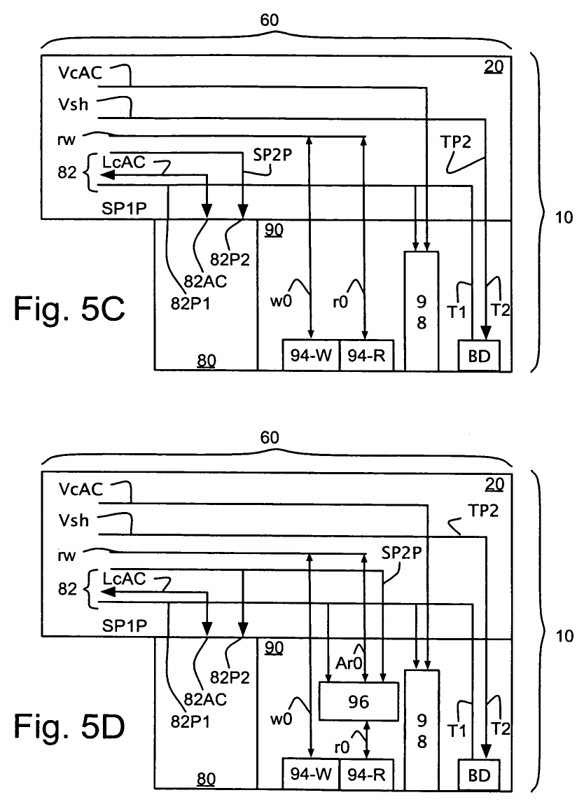

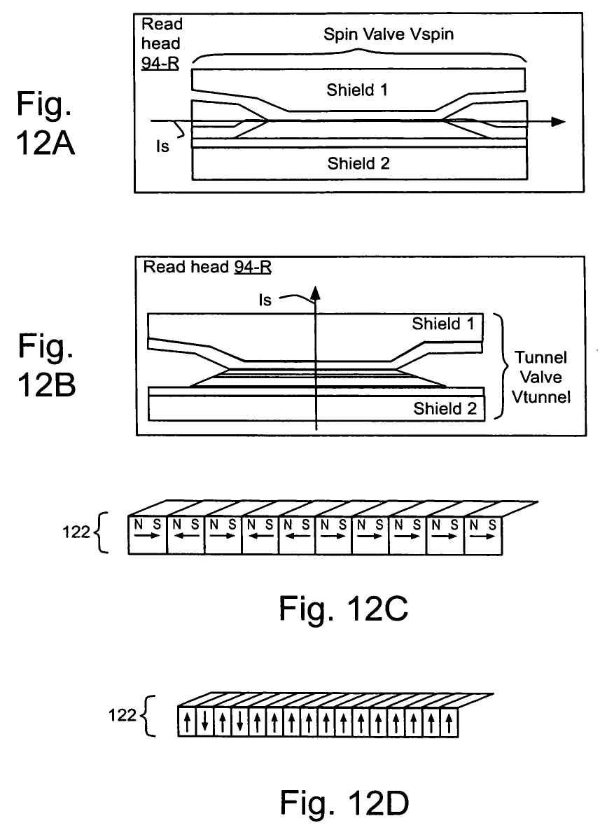

The invention's slider 90 includes the first terminal T1 and the second terminal T2. Preferably, the slider includes the bending device BD to round the first corner AF1 and the second corner AF2 of the trailing edge TE of the slider. The slider's read head 94-R may employ a spin valve Vspin as shown in FIG. 12A or a tunnel valve Vtunnel as shown in FIG. 12B. The slider may preferably include a vertical micro-actuator 98 stimulated by a third voltage VcAC across a fourth terminal and a fifth terminal to alter the vertical position Vp of the read-write head 94 above a rotating disk surface 120-1. The first terminal may preferably be electrically coupled to the third terminal as shown in FIGS. 5C and 5D.

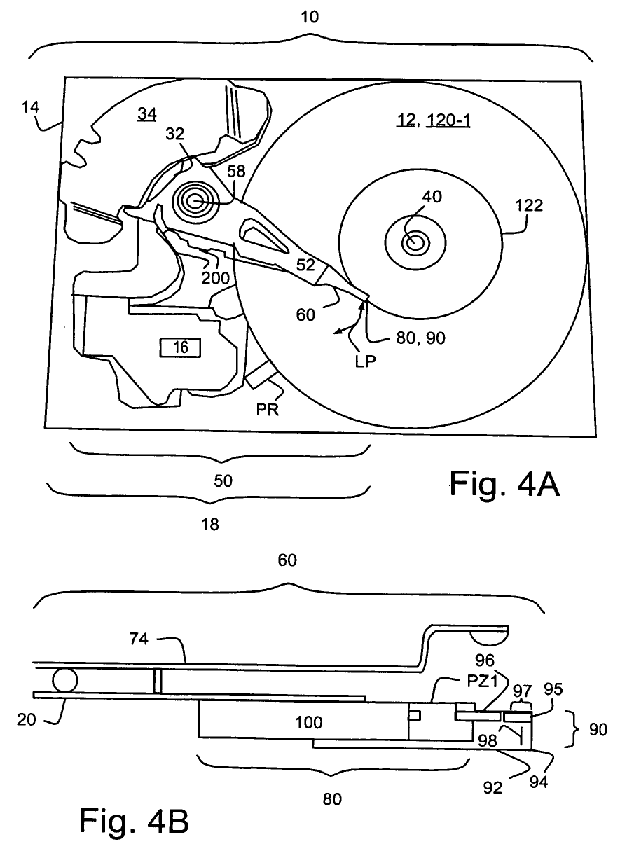

In greater detail, the read-write head 94 preferably includes a read head 94-R driving the read differential signal pair r0 and a write head 94-W receiving a write differential signal pair w0. The slider is used to access the data 122 on the rotating disk surface 120-1 in a hard disk drive 10, as shown in FIG. 4A. The data is typically organized in units known as a track 122, which are usually arranged in concentric circles on the rotating disk surface centered about a spindle shaft 40. Operating the slider to read access the data on the rotating disk surface includes the read head driving the read differential signal pair to read access the data on the rotating disk surface, and the amplifier receiving the read differential signal pair to create the amplifier read signal. The slider reports the amplified read signal as a result of read access of the data on the rotating disk surface.

The invention's slider 90 may includes the read-write head 94 providing the read-differential signal pair r0 to the amplifier 96 to generate the amplified read signal ar0, as shown in FIG. 5D.

The read head 94-R may use a spin valve Vspin to drive the read differential signal pair as shown in FIG. 12A. As used herein, the spin valve employs a magneto-resistive effect to create modulate a sensing voltage, or alternatively a sensing current Is conducted from one lead, through the magneto-resistive element, to the opposite lead. The magneto-resistive element is located between the first shield Shield1 and the second shield Shield2. The resistance of the magneto-resistive element is sensitive to the orientation of the transverse magnetic field emanating from the recording media of the disk surface. Spin valves have been in use since the mid 1990's.

The read head 94-R may use a tunnel valve Vtunnel to drive the read differential signal pair as shown in FIG. 12B. As used herein, a tunnel valve uses a tunneling effect to modulate the sensing current Is perpendicular to the first shield Shield1 and the second shield Shield2. The pinned magnetic layer is separated from the free ferromagnetic layer by an insulator, and is coupled to the pinning antiferromagnetic layer. The magneto-resistance of the tunnel valve is caused by a change in the tunneling probability, which depends upon the relative magnetic orientation of the two ferromagnetic layers. The sensing current Is, is the result of this tunneling probability. The response of the free ferromagnetic layer to the magnetic field of the bit of the track 122 of the rotating disk surface 120-1, results in a change of electrical resistance through the tunnel valve.

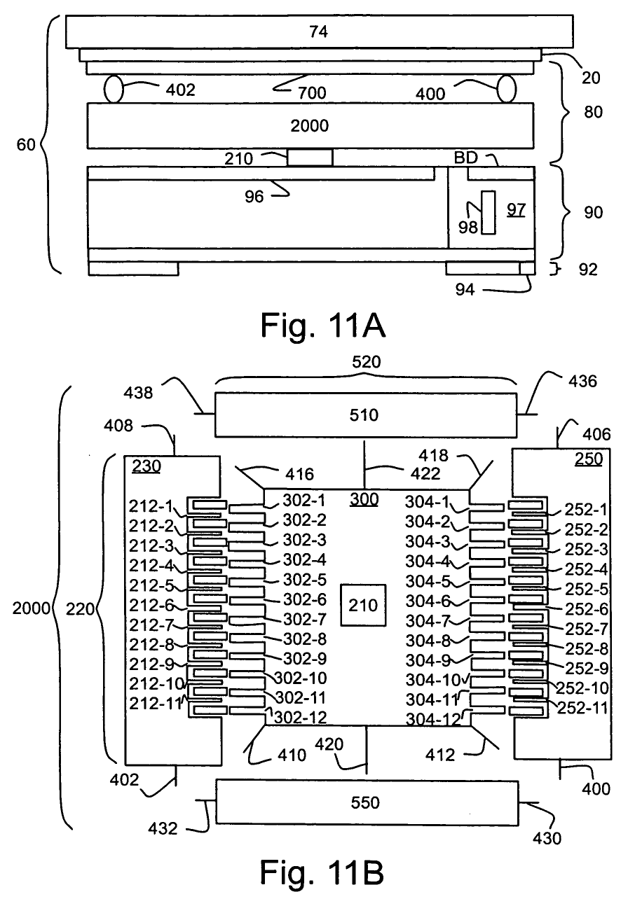

The invention's slider may further include an amplifier 96. The position of the read head 94-R relative to air bearing surface 92 is the typically same for readers using either spin valves or tunneling valves. In most but not all of the embodiments of the invention's slider 90, the amplifier is preferably opposite the air bearing surface 92, as shown in FIGS. 4B and 11A. Alternatively, the amplifier may be perpendicular to the air bearing surface, situated close to the read-write head 94, which has not been shown.

The amplified read signal ar0 may be implemented as an amplified read signal pair ar0+—as shown in FIG. 2A, or as a single ended read signal, as shown elsewhere throughout the Figures. While the decision has been made to show the amplified read signal as a single ended read signal, this has been done to simplify the discussion, and is not intended to limit the scope of the invention.

The invention's slider 90 may further include a first slider power terminal SP1 and a second slider power terminal SP2 collectively used to power the amplifier 96 in generating the amplified read signal arO, as shown in FIG. 5D.

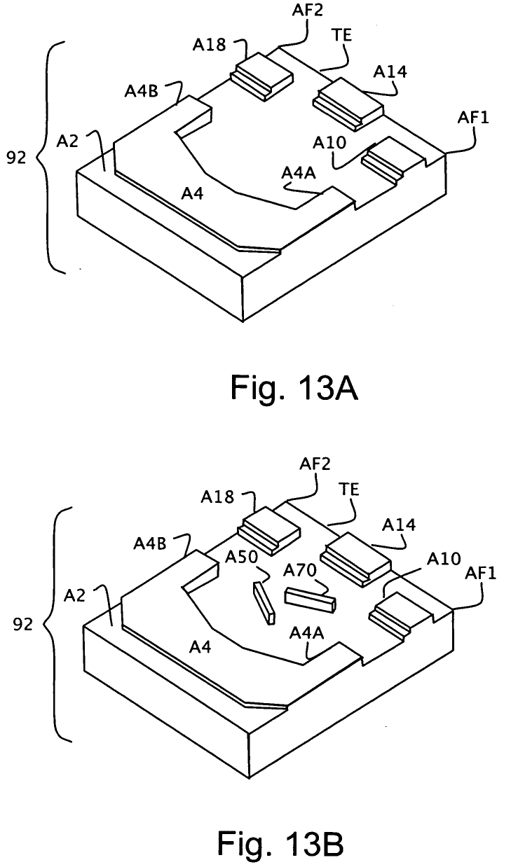

The air bearing surface 92 may include a leading air bearing surface A4 containing a left air bearing arm A4A and a right air bearing arm A4B, as well as a central island A14 near the trailing edge TE with the first corner AF1 and the second corner AF2, as shown in FIGS. 1A, 13A and 13B. The air bearing surface may further include any combination of a leading edge step A2, a left island A10 and a right island A18, as shown in FIGS. 13A and 13B. the air bearing surface may further include at least one deflection rail, as shown in FIG. 13B, which shows a left deflection rail A50 and a right deflection rail A70.

The slider 90 may include a vertical micro-actuator 98 for urging the outermost portions of the read-write head 94 closer or farther away from the rotating disk surface 120 as shown in FIGS. 4B, 5C to 8 and 11A. The vertical micro-actuator may be a thermal actuator controlled by two electrical terminals, one of which may preferably be shared with SP1 The other terminal may preferably be connected to the vertical control signal VcAC. Other forms of the vertical micro-actuator mounted to the slider may be preferable, for example a piezoelectric actuator. When a vertical micro-actuator is included in the slider, it tends to induce a strain on the materials directly coupled to it, making it preferable for the amplifier 96 to not be directly coupled to the vertical micro-actuator. The vertical micro-actuator may preferably be grounded to the load beam 74 through a via in the flexure finger 20 coupled to the load beam.

The invention's flexure finger 20 couples to the slider 90 and includes a first trace path for electrically coupling to the first terminal T1 and/or a second trace path for electrically coupled to the second terminal T2. The flexure finger may preferably further include a micro-actuator assembly 80 for coupling to the slider. The micro-actuator assembly preferably aids the slider in its lateral position LP and/or its vertical position Vp, and may employ a piezoelectric effect as shown in FIG. 4B, a thermal-mechanical effect as discussed for the vertical micro-actuator 98 and/or an electrostatic effect as shown in FIGS. 11A and 11B.

In Further detail, the flexure finger 20 for the slider 90 including the amplifier 96, providing a read trace path for the amplified read signal ar0, as shown in FIG. 5D. The lateral control signal 82 preferably includes the first lateral control signal 82P1 and the second lateral control signal 82P2, as well as the AC lateral control signal 82AC. The flexure finger may further include a micro-actuator assembly 80 for mechanically coupling with the slider to aid in positioning the slider to access the data 122 on the rotating disk surface 120-1. The micro-actuator assembly may aid in laterally positioning LP the slider to the rotating disk surface 120-1 as shown in FIG. 4A and/or aid in vertically positioning VP the slider as shown in FIGS. 1B, and 6 to 8.

As previously stated, the micro-actuator assembly 80 may employ a piezoelectric effect and/or an electrostatic effect to aid in positioning the slider 90. First, examples of micro-actuator assemblies employing the piezoelectric effect will be discussed followed by electrostatic effect examples. In several embodiments of the invention the micro-actuator assembly may preferably couple with the head gimbal assembly 60 through the flexure finger 20. The micro-actuator assembly may further couple through the flexure finger to a load beam 74 to the head gimbal assembly and consequently to the head stack assembly 50.

Examples of micro-actuator assemblies employing the piezoelectric effect are shown in FIG. 4B, showing a side view of a head gimbal assembly with a micro-actuator assembly 80 including at least one piezoelectric element PZ1 for aiding in laterally positioning LP of the slider 90. In certain embodiments, the micro-actuator assembly may consist of one piezoelectric element. The micro-actuator assembly may include the first piezoelectric element and a second piezoelectric element, which may preferably both aid in laterally positioning the slider. The micro-actuator assembly coupled with the slider may further include a third piezoelectric element to aid in the vertically positioning the slider to the rotating disk surface 120-1.

Examples of the invention using micro-actuator assemblies employing the electrostatic effect are shown in FIGS. 11A and 11B derived from the Figures of U.S. patent application Ser. No. 10/986,345, which is incorporated herein by reference. FIG. 11A shows a schematic side view of the micro-actuator assembly 80 coupling to the flexure finger 20 via a micro-actuator mounting plate 700. FIG. 11B shows the micro-actuator assembly using an electrostatic micro-actuator assembly 2000 including a first electrostatic micro-actuator 220 to aid the laterally positioning LP of the slider 90. The electrostatic micro-actuator assembly may further include a second electrostatic micro-actuator 520 to aid in the vertically positioning VP of the slider.

The first micro-actuator 220 includes the following. A first pivot spring pair 402 and 408 coupling to a first stator 230. A second pivot spring pair 400 and 406 coupling to a second stator 250. A first flexure spring pair 410 and 416, and a second flexure spring pair 412 and 418, coupling to a central movable section 300. A pitch spring pair 420-422 coupling to the central movable section 300. The central movable section 300 includes signal pair paths coupling to the amplified read signal ar0 and the write differential signal pair W0 of the read-write head 94 of the slider 90.

The bonding block 210 preferably electrically couples the read-write head 90 to the amplified read signal ar0 and write differential signal pair W0, and mechanically couples the central movable section 300 to the slider 90 with read-write head 94 embedded on or near the air bearing surface 92 included in the slider.

The first micro-actuator 220 aids in laterally positioning LP the slider 90, which can be finely controlled to position the read-write head 94 over a small number of tracks 122 on the rotating disk surface 120-1. This lateral motion is a first mechanical degree of freedom, which results from the first stator 230 and the second stator 250 electrostatically interacting with the central movable section 300. The first micro-actuator 220 may act as a lateral comb drive or a transverse comb drive, as is discussed in detail in the incorporated United States Patent Application.

The electrostatic micro-actuator assembly 2000 may further include a second micro-actuator 520 including a third stator 510 and a fourth stator 550. Both the third and the fourth stator electrostatically interact with the central movable section 300. These interactions urge the slider 90 to move in a second mechanical degree of freedom, aiding in the vertically positioning VP to provide flying height control. The second micro-actuator may act as a vertical comb drive or a torsional drive, as is discussed in detail in the incorporated United States Patent Application. The second micro-actuator may also provide motion sensing, which may indicate collision with the rotating disk surface 120-1 being accessed.

The central movable section 300 not only positions the read-write head 10, but is the conduit for the amplified read signal ar0, the write differential signal pair W0 and in certain embodiments, the first slider power signal SP1 and the second slider power signal SP2. The electrical stimulus of the first micro-actuator 220 is provided through some of its springs.

The central movable section 300 may preferably to be at ground potential, and so does not need wires. The read differential signal pair r0, write differential signal pair w0 and slider power signals SP1 and SP2 traces may preferably be routed with flexible traces all the way to the load beam 74 as shown in FIG. 11A.

The invention's head gimbal assembly 60 preferably includes the flexure finger 20 coupling to the slider 90, which preferably includes the first trace path electrically coupled to the first terminal T1 and/or the second trace path electrically coupled to the second terminal T2. The head gimbal assembly may further include the load beam 74 electrically coupling through the flexure finger to the first terminal.

When the slider 90 includes an amplifier 96 and the head gimbal assembly 60 includes the flexure finger 20 coupled with the slider, it further containing the trace path electrically coupled to the amplified read signal ar0, as shown in FIG. 5D. The head gimbal assembly operates as follows when read accessing the data 122, preferably organized as the track 122, on the rotating disk surface 120-1. The slider reports the amplified read signal as the result of the read access. The flexure finger provides the read trace path for the amplified read signal.

The slider 90 may further include a first slider power terminal SP1 and a second slider power terminal SP2, both electrically coupled to the amplifier 96 to collectively provide power to generate the amplified read signal ar0. The flexure finger 20 may further include a first power path SP1P electrically coupled to the first slider power terminal and/or a second power path SP2P electrically coupled to the second slider power terminal SP2, which are collectively used to provide electrical power to generate the amplified read signal.

The head gimbal assembly 60 may further preferably include a micro-actuator assembly 80 mechanically coupling to the slider 90 to aid in positioning the slider to access the data 122 on the rotating disk surface 120-1. The micro-actuator assembly may further include a first micro-actuator power terminal 82P1 and a second micro-actuator power terminal 82P2. The head gimbal assembly may further include the first micro-actuator power terminal electrically coupled to the first power path SP1P and/or the second micro-actuator power terminal electrically coupled to the second power path SP2P. Operating the head gimbal assembly may further preferably include operating the micro-actuator assembly to aid in positioning the slider to read access the data on the rotating disk surface, which includes providing electrical power shared by the micro-actuator assembly and by the amplifier 96 to collectively position the slider and support the amplifier generating the amplified read signal ar0.

The flexure finger 20 may be coupled to the load beam 74 as shown in FIG. 4B, which may further include the first power path SP1P electrically coupled to a metallic portion of the load beam. In certain embodiments, the metallic portion of the load beam may be essentially all of the load beam.

The head gimbal assembly 60 typically includes a base plate 72 coupled through a hinge 70 to a load beam 74 shown in an exploded view in FIG. 5B. Often the flexure finger 20 is coupled to the load beam and the micro-actuator assembly 80 and slider 90 are coupled through the flexure finger to the head gimbal assembly.

The invention's head stack assembly 50 includes a head stack 54 coupling through an actuator arm 52 to at least one head gimbal assembly 60. The head stack may couple through at least two actuator arms, each of which may couple to at least one head gimbal assembly. The head stack assembly operates as follows. The head stack assembly is prepared to be loaded onto a parking ramp PR by applying at least the first voltage V1 between the first terminal and second terminal T2, stimulating the bending device BD, and rounding the corners AF1 and AF2 of the trailing edge TE of each slider 90 included in the head stack assembly. Similarly, the head stack assembly is prepared to unload from the parking ramp by applying at least the first voltage between the first and second terminal, again rounding the corners.

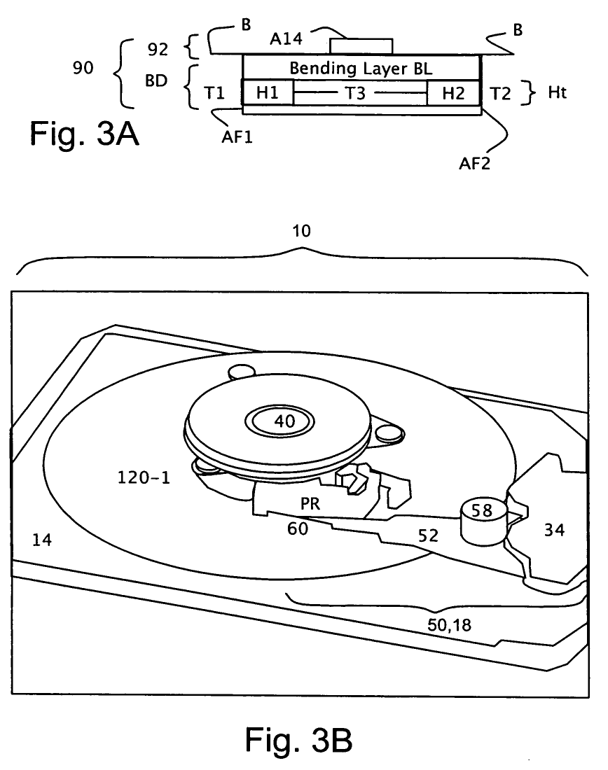

In greater detail, the head stack assembly 50 contains at least one head gimbal assembly 60 coupled to a head stack 54, as shown in FIGS. 3B, 4A, 6 to 9. The head stack assembly operates as follows when read accessing the data 122, preferably organized as the track 122, on the rotating disk surface 120-1.

The slider 90 includes an amplifier 96, it reports the amplified read signal ar0 as the result of the read access. The flexure finger provides the read trace path for the amplified read signal, as shown in FIG. 5D. The main flex circuit 200 receives the amplified read signal from the read trace path to create the read signal 25-R.

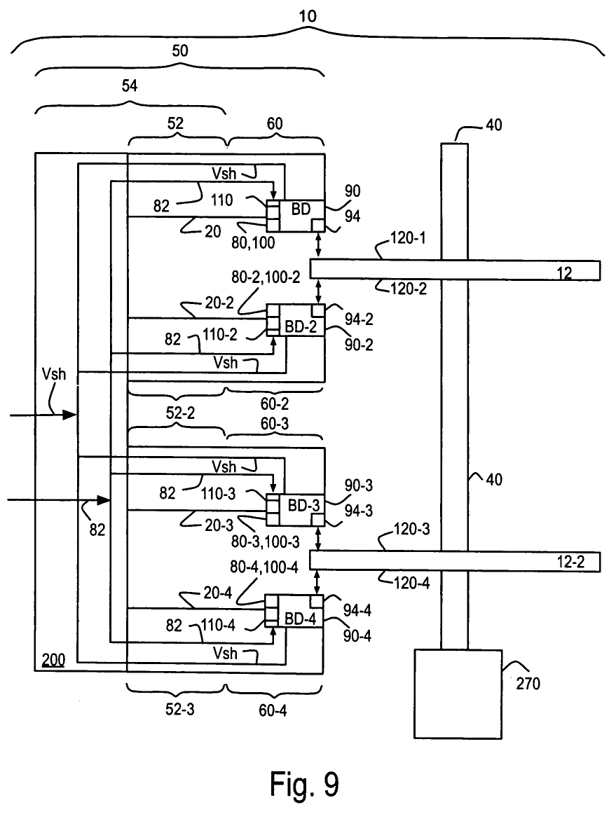

The head stack assembly 50 may include more than one head gimbal assembly 60 coupled to the head stack 54. By way of example, FIG. 9 shows the head stack assembly coupled with a second head gimbal assembly 60-2, a third head gimbal assembly 60-3 and a fourth head gimbal assembly 60-4. Further, the head stack is shown in FIGS. 3B, 4A, 6 to 8 including the actuator arm 52 coupling to the head gimbal assembly. In FIG. 9, the head stack further includes a second actuator arm 52-2 and a third actuator arm 52-3, with the second actuator arm coupled to the second head gimbal assembly 60-2 and a third head gimbal assembly 60-3, and the third actuator arm coupled to the fourth head gimbal assembly 60-4. The second head gimbal assembly includes the second slider 90-2, which contains the second read-write head 94-2. The third head gimbal assembly includes the third slider 90-3, which contains the third read-write head 94-3. And the fourth head gimbal assembly includes a fourth slider 90-4, which contains the fourth read-write head 94-4.

The head stack assembly 50 may include a main flex circuit 200 coupled with the flexure finger 20, which may further include a preamplifier 24 electrically coupled to the read trace path rtp in the read-write signal bundle rw to create the read signal 25-R based upon the amplified read signal ar0 as a result of the read access to the track 122 on the rotating disk surface 120-1.

The invention's embedded circuit 500 supports the operation of the head stack assembly 50 in the hard disk drive 10 by including the means for preparing to load MPL the head stack assembly onto the parking ramp PR and the means for preparing to unload MPU the head stack assembly from the parking ramp, both by applying at least the first voltage V1 between the first terminal T1 and the second terminal T2 of the bending device BD coupled to the slider 90, for each slider included in the head stack assembly.

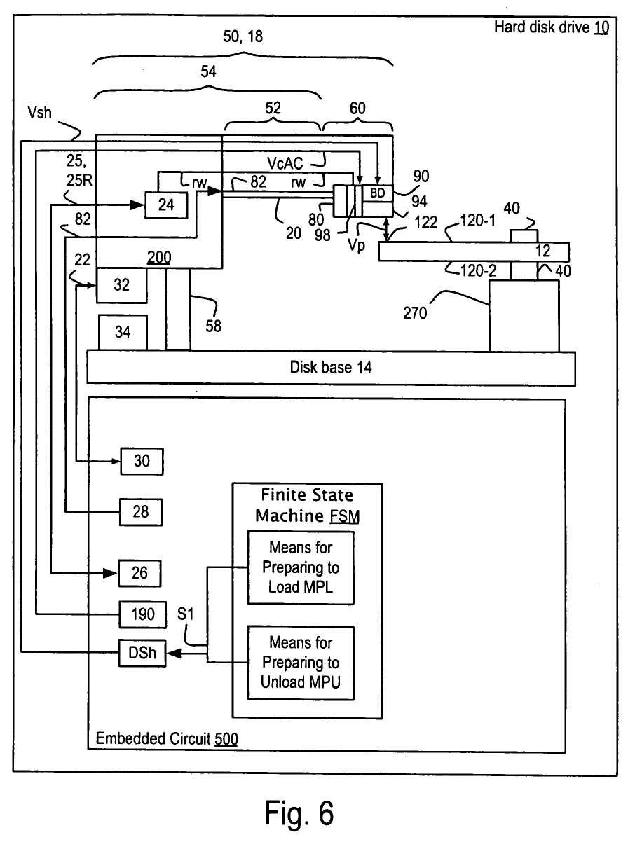

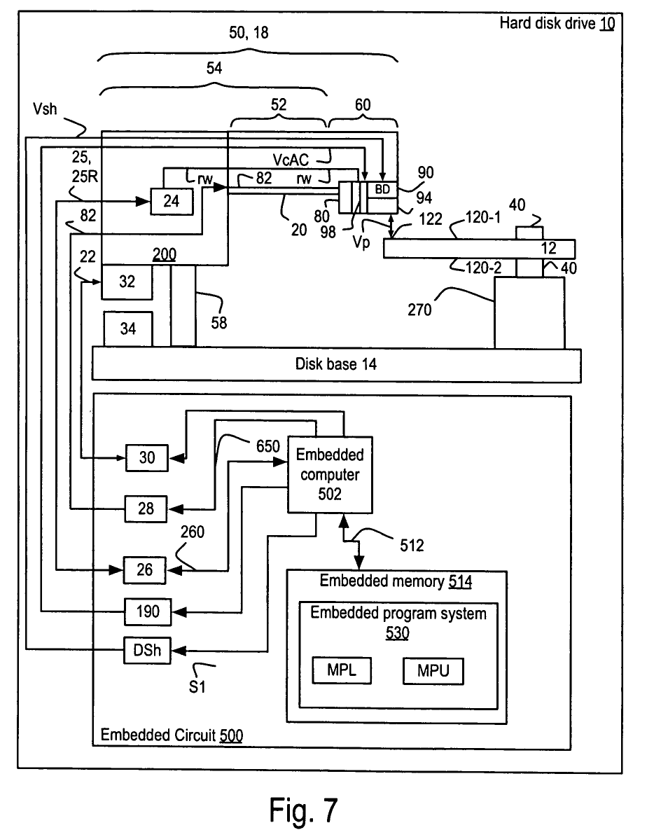

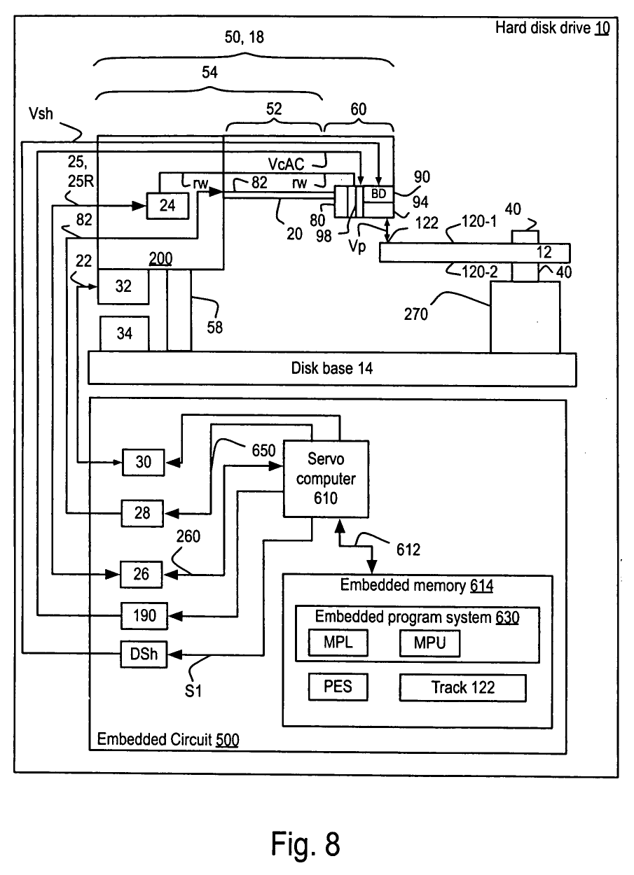

At least one of these means MPL and MPU is at least partly implemented by at least one instance of a driver DSh receiving a first signal S1 to provide a shape voltage Vsh of at least the first voltage V1 to the first terminal T1 and the second terminal T2 of the bending devices BD as shown in FIG. 6, and/or a finite state machine FSM driving the first signal and/or a computer driving the first signal, accessibly coupled to a memory and directed by a program system including at least one program step residing in the memory to support the means. The computer includes at least one data processor and at least one instruction processor. Each data processor is at least partly directed by one of the instruction processors. The computer may serve as the servo computer 610, whose primary task is to follow the track 122 based in part upon the Position Error Signal 260, as shown in FIG. 8. Alternatively the computer may serve as the embedded computer 502, as shown in FIG. 7.

The program system may preferably include program steps supporting the operations of the head stack assembly 50 in preparing to load MLP and preparing to unload MLU the head stack assembly by applying a shape voltage Vsh of at least the first voltage V1 to the bending device BD coupled to each slider 90 included in the head stack assembly. The program system may further preferably include at least one of the following program steps: directing a voice coil motor 18 to follow a track 122 on at least one rotating disk surface 120-1, which is usually performed by the servo computer 610, and accessing the track on that disk surface, which is usually performed the embedded computer 502.

The embedded circuit 500 may preferably include the servo controller 600, including a servo computer 610 accessibly coupled 612 to a memory 620. A program system 1000 may direct the servo computer in implementing the method operating the hard disk drive 10. The program system preferably includes at least one program step residing in the memory. The embedded circuit may preferably be implemented with a printed circuit technology. The lateral control signal 82 may preferably be generated by a micro-actuator driver 28. The lateral control signal preferably includes the first lateral control signal 82P1 and the second lateral control signal 82P2, as well as the AC lateral control signal 82AC.

The voice coil driver 30 preferably stimulates the voice coil motor 18 through the voice coil 32 to provide coarse position of the slider 90, in particular, the read head 94-R near the track 122 on the rotating disk surface 120-1.

The invention's hard disk drive 10 preferably includes the head stack assembly 50 electrically coupled to the embedded circuit 500 to provide at least the first voltage V1 between the first terminal T1 and the second terminal T2 of the bending device BD coupled to each slider 90 in the head stack assembly, when preparing to load MPL or preparing to unload MLU the head stack assembly from the parking ramp PR. The parking ramp may be located near the spindle shaft 40 coupling at least one disk 12 to the spindle motor 270 as shown in FIG. 3B, or located near the outside diameter OD of at least one disk as shown in FIG. 4A.

The hard disk drive 10, shown in FIGS. 3B, 4A, 5A, and 5C to 10, preferably includes the head stack assembly 50 electrically coupled to the embedded circuit 500 to process the read signal 25-R during the read access to the data 122, preferably organized as the track 122, on the rotating disk surface 120-1. The hard disk drive operates as follows when read accessing the data on the rotating disk surface. When the slider 90 includes the amplifier 96, it reports the amplified read signal ar0 as the result of the read access. The flexure finger provides the read trace path for the amplified read signal. The main flex circuit 200 receives the amplified read signal from the read trace path to create the read signal 25-R. The embedded circuit receives the read signal to read the data on the rotating disk surface. When the slider does not include the amplifier, the differential read signal pair is provided across the flexure finger to the preamplifier as a result of the read access of the data.

The hard disk drive 10 may preferably include the servo controller 600, and possibly the embedded circuit 500, coupled to the voice coil motor 18, to provide the micro-actuator stimulus signal 650 driving the micro-actuator assembly 80, and the read signal 25-R based upon the amplified read signal ar0 contained in the read-write signal bundle rw from the read-write head 94 to generate the Position Error Signal 260.

The invention includes methods for manufacturing the slider 90, the flexure finger 20, the head gimbal assembly 60, the head stack assembly 50, the embedded circuit 500, and the hard disk drive 10, as well as these items as products of the invention's manufacturing processes.

Manufacturing the invention's slider 90 includes coupling the bending device BD to the slider, further including providing the first terminal T1 and the second terminal T2 for electrical coupling with the slider. Coupling the bending device may further include bonding and/or building and/or depositing the bending device on the slider. The invention includes the slider with the coupled bending device as the product of the invention's manufacturing process. By way of example, the bending device piezoelectric film BDPZT may be deposited as at least one layer of metallic material, with the first terminal T1 and the second terminal T2 formed by etching, masking and further depositing at least one layer of conductive metal, possibly aluminum, copper, silver, and/or gold, or a combination of these metals.

Manufacturing the slider 90 may further include coupling the read-write head 94 to the amplifier 96, which further includes electrically coupling the read differential signal pair to the amplifier. The invention includes the manufacturing process of the slider and the slider as a product of that manufacturing process. The manufacturing further includes providing an air bearing surface 92 near the read head 94-R, and in some embodiments, further providing the vertical micro-actuator 98.

Coupling the read-write head 94 to the amplifier 96 may further include bonding the amplifier to the read head 94-R and/or building the amplifier to the read head. Bonding the amplifier may include gluing, and/or welding, and/or soldering the amplifier to the read head. Building the amplifier may include depositing an insulator to create a signal conditioning base, and/or using a slider substrate as a signal conditioning base, and/or depositing a first semiconductor layer on the signal conditioning base. The building may further include define at least one pattern, at least one etch of the pattern to create at least one layer, for at least one semiconducting material and at least one layer of metal to form at least one transistor circuit embodying the amplifier. The transistors preferably in use at the time of the invention include, but are not limited to, bipolar transistors, Field Effect Transistors (FETs), and amorphous transistors.

Manufacturing flexure finger 20 includes providing the first trace path and/or the second trace path to create the flexure finger. The first trace path TP1 is for electrical coupling to the first terminal, as shown in FIG. 5A. The second trace path TP2 is for electrical coupling to the second terminal T2, as shown in FIGS. 5A, 5C and 5D.

Manufacturing the invention's head gimbal assembly 60 includes coupling the flexure finger 20 to the invention's slider 90 to create the head gimbal assembly. Coupling the flexure finger to the slider may further include electrically coupling the first trace path TP1 to the first terminal T1 and/or electrically coupling the second trace path TP2 to the second terminal T2. The invention includes the manufacturing process and the head gimbal assembly as a product of the process.

Manufacturing the head gimbal assembly 60 may further includes electrically coupling the read trace path rtp with the amplified read signal ar0, when the slider 90 includes an amplifier 96. Manufacturing the head gimbal assembly may further include coupling the micro-actuator assembly 80 to the slider. Coupling the micro-actuator assembly to the slider may include electrically coupling the first micro-actuator power terminal 82P1 to the first slider power terminal SP1P and/or electrically coupling the second micro-actuator power terminal 82P2 to the second slider power terminal SP2P.

Manufacturing the invention's head stack assembly 50 includes coupling the head stack 54 through at least one actuator arm 52 to at least one of the invention's head gimbal assembly 60 to at least partly create the head stack assembly. The invention includes the manufacturing process for the head stack assembly and the head stack assembly as a product of the manufacturing process. The step coupling the head gimbal assembly 60 to the head stack 50 may further, preferably include swaging the base plate 72 to the actuator arm 52.

The manufacturing process may further include coupling more than one head gimbal assemblies to the head stack. The manufacturing may further, preferably include coupling the main flex circuit 200 to the flexure finger 20, which further includes electrically coupled the preamplifier 24 to the read trace path rtp to provide the read signal 25-R as a result of the read access of the data 122 on the rotating disk surface 120-1.

Manufacturing the embedded circuit 500 includes providing the means for preparing to load MPL and the means for preparing to unload MPU to create the embedded circuit. The invention includes this manufacturing process, and the embedded circuit as the product of that process. Providing these means may further include any or all of the following. Installing a driver DSh receiving a first signal S1 to provide at least the first voltage V1 between the first terminal T1 and the second terminal T2, for each slider 90 included in the head stack assembly 50, to at least partly create the embedded circuit. Installing a finite state machine FSM for driving the first signal. Installing a computer as shown in FIGS. 7 and 8 for driving the first signal, accessibly coupled to a memory and directed by a program system including at least one program step residing in the memory to support the means.
Installing the embedded circuit 500 may include programming the memory 620 with the program system 1000 to create the servo controller and/or the embedded circuit, preferably programming a non-volatile memory component of the memory.
Installing the embedded circuit 500, may include installing the servo computer 610 and the memory 620 into the servo controller and programming the memory with the program system 1000 to create the servo controller and/or the embedded circuit.
Installing the computer may further include programming a non-volatile memory component of the memory to create at least one program step supporting the means for preparing to load MPL and/or the means for preparing to unload MPU.

The invention includes manufacturing the hard disk drive 10 includes electrically coupling the head stack assembly 50 to the embedded circuit 500 to provide at least the first voltage V1 across the first terminal T1 and the second terminal T2, for each slider 90 included in the head stack assembly, to create the hard disk drive. The invention includes the hard disk drive as a product of this process.

Manufacturing the hard disk drive 10 may further include electrically coupling the invention's head stack assembly 50 to the embedded circuit 500 to provide the read signal 25-R as the result of the read access of the data 122 on the rotating disk surface 120-1.

Making the hard disk drive 10 may further include coupling the servo controller 600 and/or the embedded circuit 500 to the voice coil motor 18 and providing the micro-actuator stimulus signal 650 to drive the micro-actuator assembly 80.

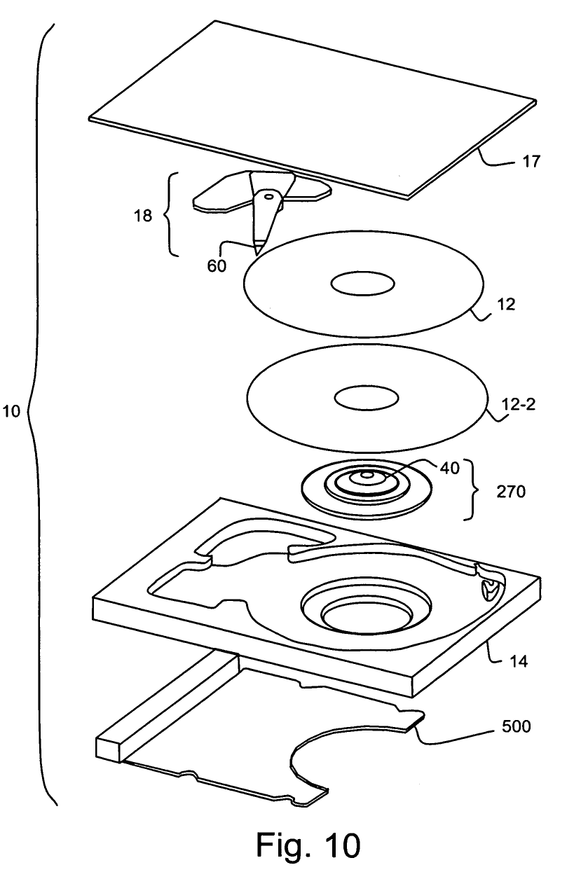

Looking at some of the details of FIGS. 9 and 10, some embodiments of the invention's hard disk drive 10 include more than one disk, for example, a disk 12 and a second disk 12-2. The disk includes the rotating disk surface 120-1 and a second rotating disk surface 120-2. The second disk includes a third rotating disk surface 120-3 and a fourth rotating disk surface 120-4. The voice coil motor 18 includes an head stack assembly 50 pivoting through an actuator pivot 58 mounted on the disk base 14, in response to the voice coil 32 mounted on the head stack 54 interacting with the fixed magnet 34 mounted on the disk base. The actuator assembly includes the head stack with at least one actuator arm 52 coupling to a slider 90 containing the read-write head 94. The slider is coupled to the micro-actuator assembly 80.

The read-write head 94 interfaces through a preamplifier 24 on a main flex circuit 200 using a read-write signal bundle rw typically provided by the flexure finger 20, to a channel interface 26 often located within the servo controller 600. The channel interface often provides the Position Error Signal 260 (PES) within the servo controller. It may be preferred that the micro-actuator stimulus signal 650 be shared when the hard disk drive includes more than one micro-actuator assembly. It may be further preferred that the lateral control signal 82 be shared. Typically, each read-write head interfaces with the preamplifier using separate read and write signals, typically provided by a separate flexure finger. For example, the second read-write head 94-2 interfaces with the preamplifier via a second flexure finger 20-2, the third read-write head 94-3 via the a third flexure finger 20-3, and the fourth read-write head 94-4 via a fourth flexure finger 20-4.

During normal disk access operations, the embedded circuit 500 and/or the servo controller 600 direct the spindle motor 270 to rotate the spindle shaft 40. This rotating is very stable, providing a nearly constant rotational rate through the spindle shaft to at least one disk 12 and sometimes more than one disk. The rotation of the disk creates the rotating disk surface 120-1, used to access the track 122 while accessing the track. These accesses normally provide for reading the track and/or writing the track.

The preceding embodiments provide examples of the invention and are not meant to constrain the scope of the following claims.

What is claimed is:

1. A method of operating a slider in a hard disk drive, comprising step:
applying at least a first voltage between a first terminal and a second terminal stimulates a bending device coupled to said slider, to produce a bending effect acting on said slider, creating a rounding at a first corner and at a second corner of the trailing edge of said slider; and
wherein applying at most a second voltage between said first terminal and said second terminal fails to stimulate said bending device, causes said first corner and said second corner to flatten; wherein said second voltage is smaller in magnitude than said first voltage.

2. The method of claim 1, wherein said second voltage is smaller in magnitude than said first voltage, comprises a member of the group consisting of:
the absolute value of said second voltage is less than said absolute value of said first voltage;
said absolute value of said second voltage is less than or equal to said absolute value of said first voltage;
said second voltage is less than said first voltage; and
said second voltage is less than or equal to said first voltage.

3. The bending device of claim 1, comprising:
said first terminal and said second terminal electrically coupling to means for stimulating to produce said bending effect for acting on said slider.

4. The bending device of claim 3, wherein means for stimulating, comprises at least one member of the group consisting of:
said first terminal electrically coupling to a piezoelectric film electrically coupled to said second terminal to expand to produce said bending effect upon stimulation by at least said first voltage; and
said first terminal electrically coupling through a heater to said second terminal to heat a bending layer coupled to said slider to produce said bending effect upon stimulation by at least said first voltage.

5. The bending device of claim 4, wherein said first terminal electrically coupling through said heater to said second terminal, further comprises:
said first terminal electrically coupling through a first heating element to a third terminal electrically coupling through a second heating element to said second terminal.

6. The bending device of claim 4, wherein said piezoelectric film includes at least one member of the group consisting of: lead, zirconium, and tungsten;
wherein said bending layer includes at least one of the group consisting of: at least one conductive material and a shape memory alloy;
wherein said conductive material includes at least one member of the group consisting of: copper, silver, lead, and gold;
wherein said shape memory alloy includes at least one solid material having at least two solid phases, wherein when said solid material is subjected to changes in temperature or pressure, said solid material tends change thermodynamic state in a manner selected from the group consisting of: from a first of said solid phases to a second of said solid phases; and from said second solid phase to said first solid phase.

7. The slider of claim 3, comprising: said first terminal and said second terminal for stimulating said bending device to round said first corner and said second corner of said trailing edge.

8. The slider of claim 7, further comprising: a read head employing a member of the group consisting of: a spin valve and a tunnel valve.

9. The slider of claim 7, further comprising: a vertical micro-actuator stimulated by a third voltage asserted across a fourth terminal and a fifth terminal to alter the vertical position of the read-write head above a rotating disk surface.

10. The slider of claim 9, wherein said first terminal is electrically coupled to said fourth terminal.

11. A method of manufacturing said slider of claim 7, comprising the step:
coupling said bending device to said slider, further comprising the steps:
providing said first terminal and said second terminal for electrical coupling with said slider.

12. The method of claim 11, wherein the step coupling said bending device, further comprises at least one member of the group consisting of the steps:
bonding said bending device to said slider;
building said bending device on said slider; and
depositing said bending device on said slider.

13. The slider as a product of the process of claim 11.

14. A flexure finger for coupling to said slider of claim 7, comprising at least one member of the group consisting of:
a first trace path for electrically coupling to said first terminal; and
a second trace path for electrically coupling to said second terminal.

15. The flexure finger of claim 14, further comprising: a micro-actuator assembly for coupling to said slider; wherein said micro-actuator assembly aids in positioning said slider in at least one member of the group consisting of: lateral position, and vertical position.

16. The flexure finger of claim 15, wherein said micro-actuator assembly employs at least one member of the group consisting of: a piezoelectric effect, a thermal-mechanical effect and an electrostatic effect.

17. A method of manufacturing said flexure finger of claim 14, comprising the step:
providing at least one member of a trace group to create said flexure finger;
wherein said trace group consists of the members: said first trace path and said second trace path.

18. The flexure finger as a product of the process of claim 17.

19. A head gimbal assembly, comprising said flexure finger of claim 14 coupling to said slider, further comprising at least one member of the group consisting of:
said first trace path electrically coupled to said first terminal; and
said second trace path electrically coupled to said second terminal.

20. The head gimbal assembly of claim 19, further comprising: a load beam electrically coupling through said flexure finger to said first terminal.

21. A method of manufacturing said head gimbal assembly of claim 19, comprising the step: coupling said flexure finger to said slider, further comprising at least one member of the group consisting of the steps:
electrically coupling said first trace path to said first terminal; and
electrically coupling said second trace path to said second terminal.

22. The head gimbal assembly as a product of the process of claim 21.

23. A head stack assembly, comprising: a head stack coupling through an actuator arm to at least one of said gimbal assemblies of claim 19.

24. The head stack assembly of claim 23, wherein said head stack couples through at least two actuator arms, whereby each of said actuator arms couples to at least one of said head gimbal assemblies.

25. A method of manufacturing said head stack assembly of claim 23, comprising the step:
coupling said head stack through at least one of said actuator arms, each to at least one of said head gimbal assemblies to create said head stack assembly.

26. The head stack assembly as a product of the process of claim 25.

27. A method of operating said head stack assembly of claim 23 in said hard disk drive, comprising the steps:
preparing to load said head stack assembly onto a parking ramp by applying at least said first voltage between said first terminal and said second terminal, stimulating said bending device coupled to said slider, for each of said sliders included in said head stack assembly; and
preparing to unload said head stack assembly from said parking ramp by applying at least said first voltage between said first terminal and said second terminal, stimulating said bending device coupled to said slider, for each of said sliders included in said head stack assembly.

28. An embedded circuit supporting the method of claim 27, comprising:
means for preparing to load said head stack assembly onto said parking ramp by applying said first voltage between said first terminal and said second terminal, for each of said sliders included in said head stack assembly; and
means for preparing to unload said head stack assembly from said parking ramp by applying said first voltage between said first terminal and said second terminal, for each of said sliders included in said head stack assembly.

29. The embedded circuit of claim 28, wherein at least one member of the group consisting of said means for preparing to load and said means for preparing to unload, is at least partly implemented by at least one instance of at least one member of the group consisting of:
a driver receiving a first signal to provide said first voltage between said first terminal and said second terminal, for each of said sliders included in said head stack assembly;
a finite state machine driving said first signal; and
a computer driving said first signal, accessibly coupled to a memory and directed by a program system including at least one program step residing in said memory to support said means;
wherein said computer includes at least one data processor and at least one instruction processor; wherein each of said data processors is at least partly directed by at least one of said instruction processors.

30. The embedded circuit of claim 29, wherein said program system, comprises the program steps:
preparing to load said head stack assembly onto said parking ramp by applying said first voltage between said first terminal and said second terminal, stimulating said bending device coupled to said slider, for each of said sliders included in said head stack assembly; and
preparing to unload said head stack assembly from said parking ramp by applying said first voltage between said first terminal and said second terminal, stimulating said bending device coupled to said slider, for each of said sliders included in said head stack assembly.

31. The embedded circuit of claim 29, wherein said program system further includes at least one at least one member of the group consisting of:
directing a voice coil motor to follow a track on one of said disk surfaces; and
accessing said track on said one of said disk surfaces.

32. A method of manufacturing said embedded circuit of claim 28, comprising the step:
providing said means for preparing to load and said means for preparing to unload to create said embedded circuit.

33. The embedded circuit as a product of the process of claim 32.

34. The method of claim 32, wherein the step providing further comprises at least one member of the group consisting of:
installing a driver receiving a first signal to provide at least said first voltage between said first terminal and said second terminal, for each of said sliders included in said head stack assembly, to at least partly create said embedded circuit;
installing a finite state machine for driving said first signal; and
installing a computer for driving said first signal, accessibly coupled to a memory and directed by a program system including at least one program step residing in said memory to support said means.

35. The method of claim 34, wherein the step installing said computer, further comprises the step:
programming a non-volatile memory component of said memory to create said means.

36. The hard disk drive of claim 28, comprising: said head stack assembly electrically coupled to said embedded circuit to provide at least said first voltage across said first terminal and said second terminal, for each of said sliders included in said head stack assembly,
when said hard disk drive prepares to load said head stack assembly onto said parking ramp, and
when said hard disk drive prepares to unload said head stack assembly onto said parking ramp.

37. The hard disk drive of claim 36, wherein said parking ramp is located near the spindle each of said disks included in said hard disk drive to a spindle motor.

38. The hard disk drive of claim 36, wherein said parking ramp is located near an outside diameter of at least one disk included in said hard disk drive.

39. A method of manufacturing said hard disk drive of claim 36, comprising the step:
electrically coupling said head stack assembly to said embedded circuit to provide at least said first voltage across said first terminal and said second terminal, for each of said sliders included in said head stack assembly, to create said hard disk drive.

40. The hard disk drive as a product of the process of claim 39.
